(19) United States
(12) Patent Application Publication
(10) Pub. No.: US 2026/0324597 A1
(43) Pub. Date: Oct. 22, 2026

(54) WEARABLE ELECTRONIC DEVICE FOR ANIMAL AND FLEXIBLE CONNECTING PORTION THEREOF

(71) Applicant: Hable Hound Inc, Dover, DE (US)

(72) Inventors: Xiaoxuan Chen, Shenzhen (CN); Jian Huang, Shenzhen (CN); Yanbo Zheng, Shenzhen (CN)

(21) Appl. No.: 19/688,592

(22) Filed: May 27, 2026

(30) Foreign Application Priority Data
Mar. 19, 2026 (CN) 202610344362.5

(51) Int. Cl. A01K 27/00

(52) U.S. Cl. CPC A01K 27/001

(57) ABSTRACT

A wearable electronic device for an animal includes at least two functional assemblies each having an independent rigid housing; a flexible connecting portion connected between two adjacent functional assemblies; and a wearing member on which at least a portion of the functional assemblies is mounted. When the device is worn on the animal, adjacent functional assemblies undergo relative positional and orientational changes via the flexible connecting portion, thereby accommodating torso or neck deformation of the animal during movement and differences in torso or neck curvature caused by different animal body sizes. The flexible connecting portion includes a first connection end, a second connection end, and a flexible or deformable connection body located between the first and second connection ends, the connection body permitting the relative positional and orientational changes. The flexible connecting portion can conform flexibly to the animal's body surface while maintaining rigid protection for the functional assemblies.

### CROSS REFERENCE TO RELATED APPLICATIONS

The present application claims the benefit of Chinese Patent Application No. 202610344362.5 filed on Mar. 19, 2026, the contents of which are incorporated herein by reference in their entirety.

### FIELD OF THE INVENTION

The present disclosure relates to the field of wearable articles for animals, and more particularly to a wearable electronic device for an animal and a flexible connecting portion thereof.

### BACKGROUND OF THE INVENTION

Currently, in existing wearable electronic devices for animals, an independent housing is typically employed, or multiple functional components are collectively mounted to a unified base structure or a main housing structure, which is then connected to a wearing band via the unified base structure or the main housing structure.

However, during animal movements such as running, jumping, turning, and pitching, the surface curvature and deformation of the animal's neck or torso are significant. A centralized or large-volume rigid structure is prone to causing local compression and poor conformance to the animal, leading to issues such as reduced wearing comfort, slippage and flipping, structural stress concentration, seal failure, and reduced assembly reliability in existing wearable electronic devices for animals.

Moreover, multifunctional components demand protection and sealing, but the independent housing struggles to achieve both compliant conformance and reliable protection. On the other hand, employing a unified base structure or main housing structure with separate compartments tends to introduce problems such as increased bulk and weight, heightened risk of flipping, and inconvenient maintenance.

Accordingly, there is a need for a wearable electronic device for an animal and a flexible connecting portion thereof that can conform flexibly and accommodate body surface deformation of the animal while maintaining rigid protection, thereby reducing local compression and stress concentration.

### SUMMARY OF THE INVENTION

One object of the present disclosure is to provide a wearable electronic device for an animal that can conform flexibly and accommodate body surface deformation of the animal while maintaining rigid protection, thereby reducing local compression and stress concentration.

Another objective of the present disclosure is to provide a flexible connecting portion for a wearable electronic device for an animal that can conform flexibly and accommodate body surface deformation of the animal while maintaining rigid protection, thereby reducing local compression and stress concentration.

To achieve the above objects, the present disclosure provides a wearable electronic device for an animal, including at least two functional assemblies spaced apart from each other, each of the functional assemblies having an independent rigid housing; a flexible connecting portion connected between two adjacent functional assemblies and configured to permit relative positional and orientational changes between the two adjacent functional assemblies; a wearing member, on which at least a portion of the functional assemblies is mounted. When the wearable electronic device is worn on the animal, the two adjacent functional assemblies undergo relative positional and orientational changes via the flexible connecting portion, thereby accommodating torso or neck deformation of the animal during movement, and accommodating differences in torso or neck curvature caused by different animal body sizes.

Compared with the prior art, the wearable electronic device for an animal according to the present disclosure provides several beneficial effects. First, by distributing multiple functional assemblies and providing a flexible connection between adjacent functional assemblies, the wearable electronic device can adapt to the curvature and movement-induced deformation of the animal's body surface, thereby reducing local compression and stress concentration on the animal. Second, each functional assembly is equipped with an independent rigid housing, which facilitates reliable protection and sealing while still allowing the overall assembly to flexibly conform to the animal's body. Third, the wearable electronic device eliminates the need for a unified base structure or main unit, thereby reducing the discomfort associated with bulky, concentrated components and improving wearing stability.

In a preferred embodiment, the wearing member is a collar, a chest strap, or a harness.

In a preferred embodiment, all of the functional assemblies are spaced apart from each other along a length direction of the wearing member.

In a preferred embodiment, the flexible connecting portion is configured to permit an angular change between two adjacent functional assemblies; or the flexible connecting portion is configured to permit an angular change and a translational movement between two adjacent functional assemblies.

In a preferred embodiment, the flexible connecting portion is an elastomeric connector, a bellows-structure connector, a serpentine connector, a flexible sheet-like connector, or a fabric composite connector.

In a preferred embodiment, an end portion of each functional assembly is provided with an end connection interface structure configured to cooperate with the flexible connecting portion.

In a preferred embodiment, the end connection interface structure is connected to the flexible connecting portion by overmolding, snap-fitting, or embedded/interlocking engagement.

In a preferred embodiment, the end connection interface structure is located on the rigid housing.

In a preferred embodiment, the end connection interface structure includes an annular protruding ring, an annular groove, a plug-in portion, a snap-fit portion, or a positioning flange.

In a preferred embodiment, each functional assembly defines a communication channel therein, and the flexible connecting portion defines an electrical connection channel aligned and in communication with the communication channel.

In a preferred embodiment, the electrical connection channel is provided with a conductive member configured to electrically connect two adjacent functional assemblies.

In a preferred embodiment, the conductive member is an electrical wire or a flexible circuit board.

In a preferred embodiment, the flexible connecting portion is provided with a rigid tongue inserted into the end connection interface structure through the communication channel, the electrical connection channel extending through the rigid tongue in an insertion direction. The end connection interface structure includes an annular protruding ring arranged around the communication channel, and the functional assembly is provided with a pressing plate. When the pressing plate presses against the rigid tongue in a direction intersecting the insertion direction, the pressing plate causes the rigid tongue to continue moving in the insertion direction and causes the annular protruding ring to sealingly abut the flexible connecting portion.

In a preferred embodiment, the end connection interface structure includes an annular protruding ring arranged around the communication channel and overmolded with the flexible connecting portion.

In a preferred embodiment, a sidewall of the annular protruding ring defines an annular groove extending circumferentially around the annular protruding ring, the annular groove being overmolded with the flexible connecting portion.

In a preferred embodiment, each functional assembly further includes at least one of a positioning module, a sensing module, a wireless communication module, or a power module.

In a preferred embodiment, the wireless communication module includes at least one of a cellular communication module, a Bluetooth module, or a Wi-Fi communication module.

To achieve the above objects, the present disclosure provides a flexible connecting portion for a wearable electronic device for an animal. The flexible connecting portion is connected between two adjacent functional assemblies that are spaced apart from each other in the wearable electronic device. The flexible connecting portion includes a first connection end configured to cooperate with an end connection interface structure of a first one of the two adjacent functional assemblies; a second connection end configured to cooperate with an end connection interface structure of a second one of the two adjacent functional assemblies; and a flexible or deformable connection body located between the first connection end and the second connection end, the connection body permitting relative positional and orientational changes between the two adjacent functional assemblies.

Compared with the prior art, the flexible connecting portion for the wearable electronic device according to the present disclosure also provides several beneficial effects. First, the flexible connection between adjacent functional assemblies allows the wearable electronic device to adapt to the curvature and movement-induced deformation of the animal's body surface, thereby reducing local compression and stress concentration on the animal. Second, each functional assembly is equipped with an independent rigid housing, which facilitates reliable protection and sealing while still allowing the overall assembly to flexibly conform to the animal's body. Third, the wearable electronic device eliminates the need for a unified base structure or main unit, thereby reducing the discomfort associated with bulky, concentrated components and improving wearing stability.

In a preferred embodiment, the flexible connecting portion defines an electrical connection channel therein, and each functional assembly defines a communication channel aligned and in communication with the electrical connection channel.

In a preferred embodiment, the electrical connection channel is provided with a conductive member configured to electrically connect two adjacent functional assemblies.

In a preferred embodiment, the conductive member is an electrical wire or a flexible circuit board.

In a preferred embodiment, the first connection end and the second connection end are configured to be connected to the respective end connection interface structures of the corresponding functional assemblies by overmolding, snap-fitting, or embedded/interlocking engagement.

### BRIEF DESCRIPTION OF THE DRAWINGS

The accompanying drawings facilitate an understanding of the various embodiments of this invention. In such drawings:

FIG. 1 is a plan view of a wearable electronic device for an animal according to a first embodiment of the present disclosure, viewed along a width direction thereof;

FIG. 2 is a plan view of the wearable electronic device for an animal shown in FIG. 1, with a collar omitted;

FIG. 3 is a cross-sectional view of the device shown in FIG. 2, taken along a bisecting plane in the width direction thereof;

FIG. 4 is an enlarged view of portion B of FIG. 3;

FIG. 5 is an enlarged view of portion C of FIG. 3;

FIG. 6 is an enlarged view of portion D of FIG. 3;

FIG. 7 is a cross-sectional view showing an alternative connection configuration between a second connection end of a flexible connecting portion and an end connection interface structure of a functional assembly; and

FIG. 8 is a perspective view of a wearable electronic device for an animal according to a second embodiment of the present disclosure, with a chest strap omitted.

### DETAILED DESCRIPTION OF ILLUSTRATED EMBODIMENTS

The technical content and structural features of the present disclosure will be described in detail below with reference to the accompanying drawings and exemplary embodiments.

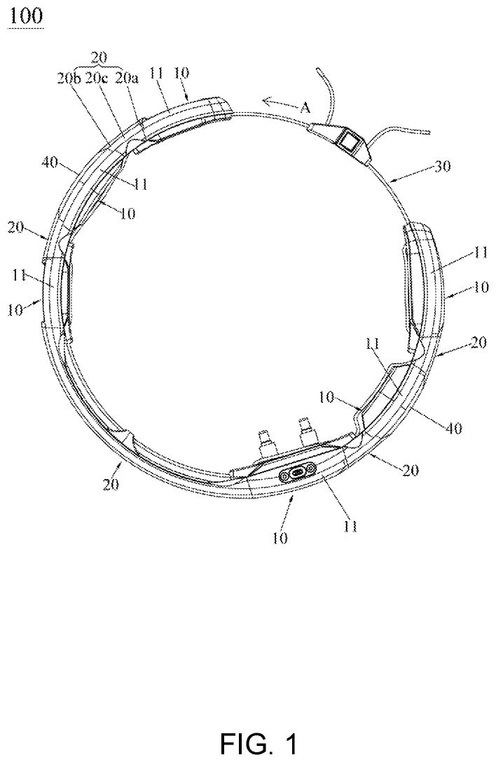

Referring to FIG. 1, a wearable electronic device 100 for an animal according to a first embodiment of the present disclosure is configured to be worn on an animal's neck, and includes functional assemblies 10, flexible connecting portions 20, and a collar 30.

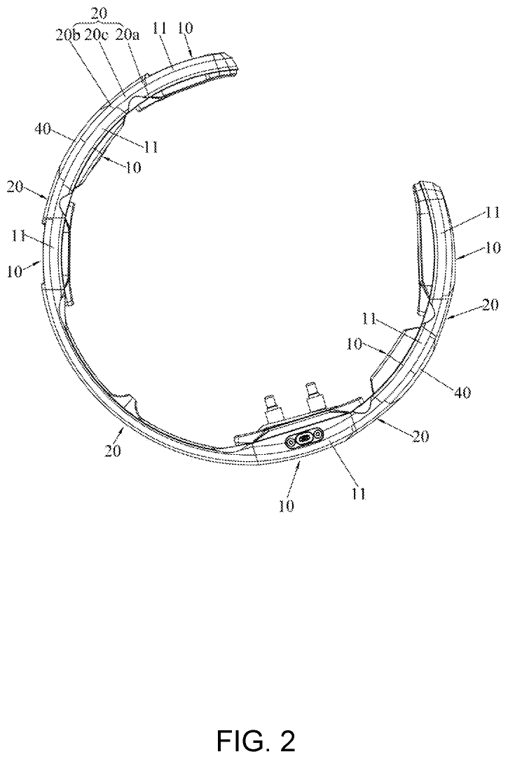

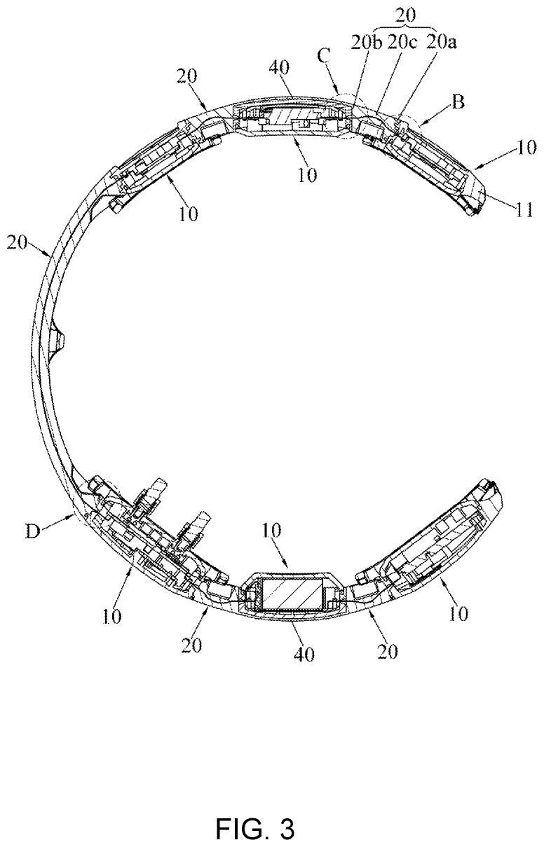

Referring to FIGS. 2 and 3, six functional assemblies 10 are provided spaced apart from each other. It should be understood that depending on actual needs, the number of functional assemblies 10 may be two, three, four, five, seven, or more, and thus the present disclosure is not limited to the configuration shown in FIGS. 1 to 3. Optionally, as an example in FIG. 1, all of the functional assemblies 10 are spaced apart from each other along a length direction of the collar 30, so as to more effectively distribute body surface pressure on the animal's neck when the wearable electronic device 100 according to the first embodiment is in a worn state, and to improve conformity. Additionally, each functional assembly 10 has an independent rigid housing 11 for accommodating circuit components of that functional assembly 10 and providing waterproof, dustproof, and impact-resistant protection. Furthermore, all of the functional assemblies 10 are mounted on the collar 30, such that when the wearable electronic device 100 according to the first embodiment is in a worn state, the collar 30 maintains the functional assemblies 10 in close conformity with the skin of the animal's neck. It should be understood that depending on actual needs, only some of the functional assemblies 10 may be mounted on the collar 30, and thus the present disclosure is not limited to the configuration shown in FIGS. 1 to 3.

Each of the flexible connecting portions 20 is disposed between two adjacent functional assemblies 10, such that adjacent functional assemblies 10 are connected via the flexible connecting portion 20. This overcomes the drawbacks of the prior art that require a unified base structure for collectively carrying, compartmentally accommodating, or centrally mounting multiple functional assemblies, thereby avoiding the risks of overturning and insufficient conformity caused by the bulkiness of concentrated structures. Moreover, the flexible connecting portions 20 permit relative positional and orientational changes between adjacent functional assemblies 10. For example, the flexible connecting portions may permit an angular change between adjacent functional assemblies 10, or may permit an angular change and a degree of freedom of translational movement, so as to adapt to changes in curvature and deformation of the animal's body surface during movement. Optionally, as an example, the flexible connecting portion 20 may be an elastomeric connector, a bellows-structure connector, a serpentine connector, a flexible sheet-like connector, or a fabric composite connector, each of which achieves the objective of permitting relative positional and orientational changes between adjacent functional assemblies 10.

Thus, when the wearable electronic device 100 according to the first embodiment is in the worn state, adjacent functional assemblies 10 undergo relative positional and orientational changes via the flexible connecting portions 20, thereby accommodating neck deformation of the animal during movement and differences in neck curvature caused by different animal body sizes. More specific details are described below.

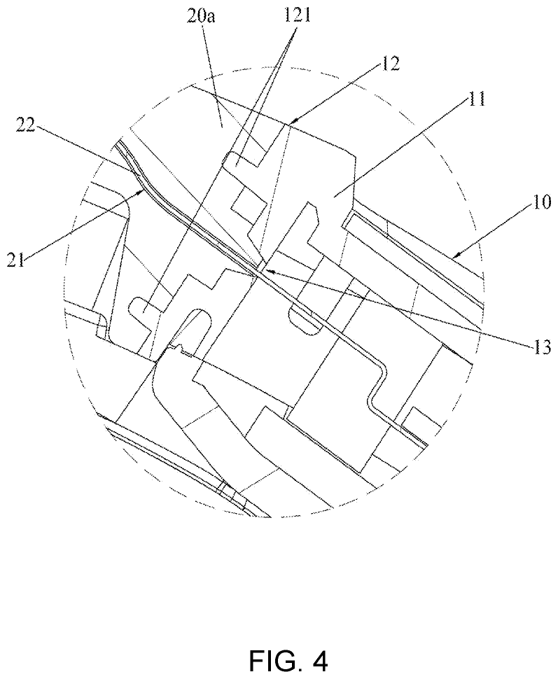

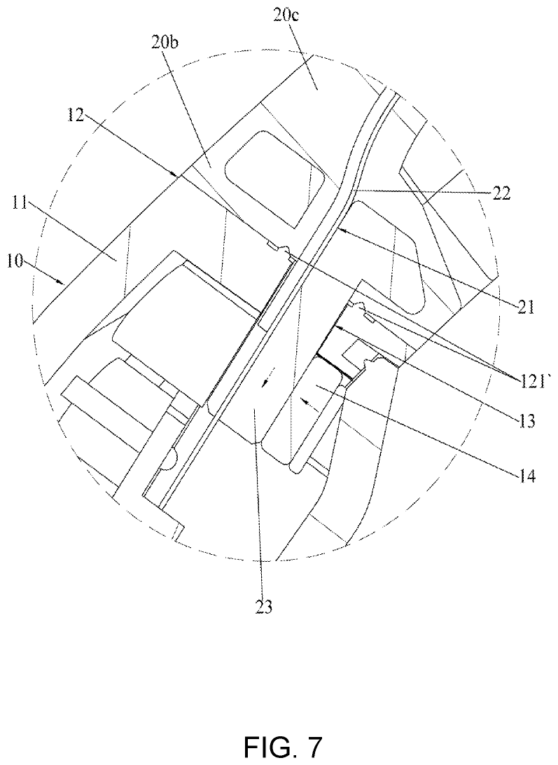

As shown in FIGS. 4 to 7, as an example, an end portion of each functional assembly 10 is provided with an end connection interface structure 12 configured to cooperate with the flexible connecting portion 20. Optionally, as an example in FIGS. 4 to 7, the end connection interface structure 12 is located on the rigid housing 11. Specifically, as an example in FIGS. 4 to 6, the end connection interface structure 12 is overmolded with the flexible connecting portion 20. By virtue of overmolding, on the one hand, the connection operation between the functional assembly 10 and the flexible connecting portion 20 is simplified, and on the other hand, the waterproof and dustproof capabilities between the functional assembly 10 and the flexible connecting portion 20 are enhanced. It should be understood that depending on actual needs, the end connection interface structure 12 may also be interlockingly engaged or snap-fitted with the flexible connecting portion 20 (an interlocking engagement configuration is shown in FIG. 7). Additionally, as an example in FIGS. 4 to 7, each functional assembly 10 defines a communication channel 13 therein, and the flexible connecting portion 20 defines an electrical connection channel 21 aligned and in communication with the communication channel 13. The electrical connection channel 21 is provided with a conductive member 22 configured to electrically connect two adjacent functional assemblies 10. The conductive member 22 may be an electrical wire or a flexible circuit board, so as to enable transmission of electrical energy and electrical signals between adjacent functional assemblies 10, and to improve the reliability and consistency of wiring and electrical connection among the functional assemblies 10.

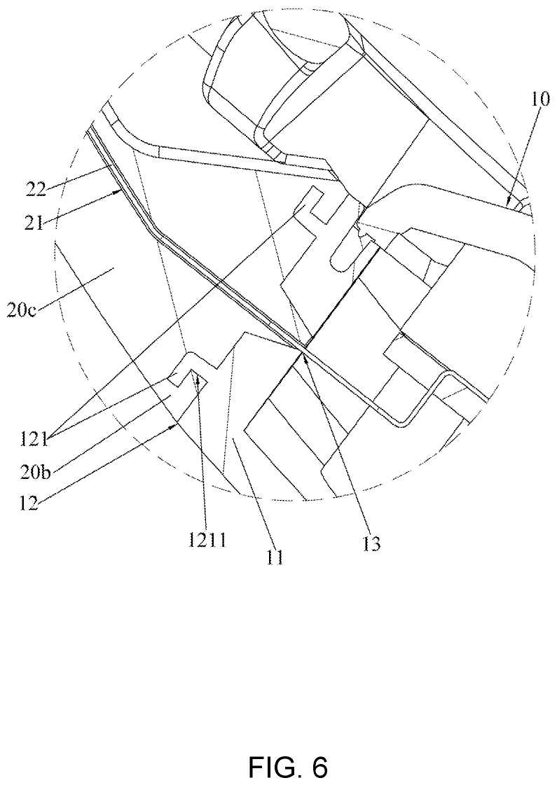

More specifically, as an example in FIG. 4, the end connection interface structure 12 includes an annular protruding ring 121 arranged around the communication channel 13 and overmolded with the flexible connecting portion 20, so as to increase the overmolding area between the functional assembly 10 and the flexible connecting portion 20. Optionally, as an example in FIG. 6, a sidewall of the annular protruding ring 121 defines an annular groove 1211 extending circumferentially around the annular protruding ring 121 and overmolded with the flexible connecting portion 20, thereby further increasing the overmolding area between the functional assembly 10 and the flexible connecting portion 20.

In addition, as shown in FIG. 7, a specific manner of achieving interlocking engagement between the end connection interface structure 12 and the flexible connecting portion 20 is provided. The flexible connecting portion 20 is provided with a rigid tongue 23 inserted into the end connection interface structure 12 through the communication channel 13. The electrical connection channel 21 extends through the rigid tongue 23 in an insertion direction (indicated by the dashed arrow within the rigid tongue 23 in FIG. 7). The end connection interface structure 12 includes an annular protruding ring 121′ arranged around the communication channel 13. The functional assembly 10 is provided with a pressing plate 14. When the pressing plate 14 presses against the rigid tongue 23 in a direction intersecting the insertion direction (indicated by the dashed arrow within the pressing plate 14 in FIG. 7), the pressing plate 14 causes the rigid tongue 23 to continue moving in the insertion direction and simultaneously causes the annular protruding ring 121′ to sealingly abut the flexible connecting portion 20, thereby further improving the waterproof and dustproof effect.

As shown in FIGS. 1 to 3, each functional assembly 10 further includes at least one of a positioning module, a sensing module, a wireless communication module, or a power module. The wireless communication module includes at least one of a cellular communication module, a Bluetooth module, or a Wi-Fi communication module. Specifically, in FIG. 3, proceeding in a counterclockwise direction, the functional assembly 10 at a first position and the functional assembly 10 at a third position are solar photovoltaic functional assemblies; the functional assembly 10 at a second position is a communication functional assembly; the functional assembly 10 at a fourth position is a main unit functional assembly (e.g., an MCU unit module, though not limited thereto); and the functional assembly 10 at a fifth position is a battery functional assembly.

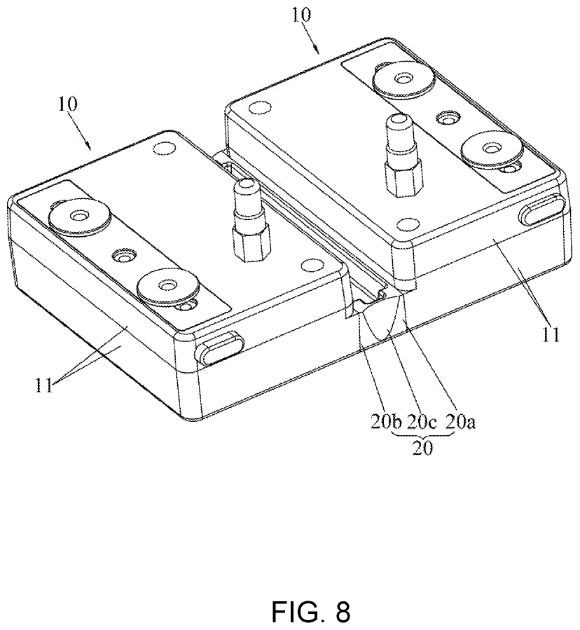

Referring to FIG. 8, a wearable electronic device according to a second embodiment has substantially the same structure as the wearable electronic device 100 according to the first embodiment, with the differences set forth below.

First, the wearable electronic device according to the second embodiment is configured to be worn on the animal's torso, and correspondingly, its wearing member is a chest strap or a harness. In contrast, the wearable electronic device 100 according to the first embodiment is configured to be worn on the animal's neck, and correspondingly, its wearing member is a collar 30. That is, the wearing member may be a collar, chest strap, or harness.

Second, in FIG. 8, the wearable electronic device according to the second embodiment includes two functional assemblies 10. In contrast, in FIGS. 1 to 3, the wearable electronic device 100 according to the first embodiment includes six functional assemblies 10.

Apart from the above differences, the other structures of the wearable electronic device according to the second embodiment are the same as those of the wearable electronic device 100 according to the first embodiment, and thus are not further described herein.

Referring to FIGS. 1 to 3, the present disclosure further provides a flexible connecting portion 20 for a wearable electronic device 100. The flexible connecting portion 20 is disposed between two adjacent functional assemblies 10 that are spaced apart from each other in the wearable electronic device 100, such that the two functional assemblies 10 are connected via the flexible connecting portion 20.

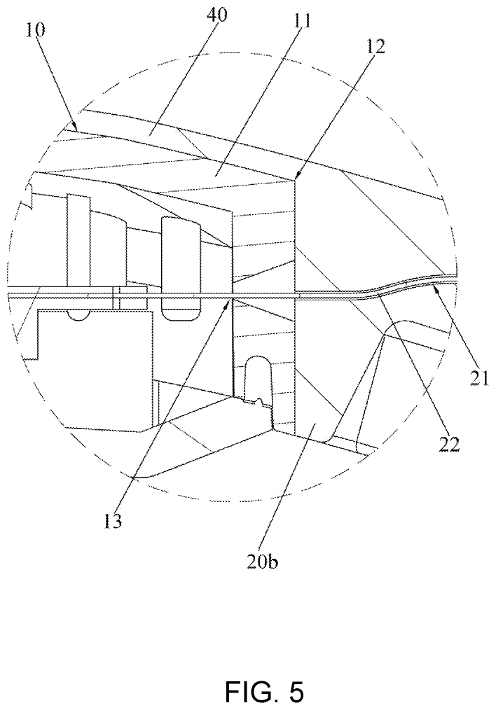

Referring to FIGS. 4 and 5, the flexible connecting portion 20 includes a first connection end 20a, a second connection end 20b, and a flexible or deformable connection body 20c. The first connection end 20a is configured to cooperate with the end connection interface structure 12 of a first one of the two functional assemblies 10. The second connection end 20b is configured to cooperate with the end connection interface structure 12 of a second one of the two functional assemblies 10. The connection body 20c is located between the first connection end 20a and the second connection end 20b, and permits relative positional and orientational changes between the two functional assemblies 10.

Specifically, as an example in FIGS. 4 and 5, the first connection end 20a and the second connection end 20b are configured to be overmolded with the respective end connection interface structures 12 of the corresponding functional assemblies 10. It should be understood that depending on actual needs, the first connection end 20a and the second connection end 20b may also be configured to be snap-fitted or interlockingly engaged with the respective end connection interface structures 12 of the corresponding functional assemblies 10.

More specifically, as an example in FIG. 4, the end connection interface structure 12 includes an annular protruding ring 121 arranged around the communication channel 13 and overmolded with the first connection end 20a of the flexible connecting portion 20. Optionally, as an example in FIG. 6, a sidewall of the annular protruding ring 121 defines an annular groove 1211 extending circumferentially around the annular protruding ring 121 and overmolded with the flexible connecting portion 20, thereby further increasing the overmolding area between the functional assembly 10 and the first connection end 20a of the flexible connecting portion 20. It should be understood that depending on actual needs, the end connection interface structure 12 of the functional assembly 10 corresponding to the second connection end 20b may be provided without an annular protruding ring 121, as shown in FIG. 5.

To further simplify assembly operations for three functional assemblies 10 consecutively arranged, such as the functional assemblies 10 at the first through third positions in the counterclockwise direction in FIG. 3, and the functional assemblies 10 at the fourth through sixth positions in the counterclockwise direction in FIG. 3, adjacent flexible connecting portions 20 are integrally connected via an overmolded connecting portion 40. The overmolded connecting portion 40 overmolds the outer side (the side facing away from the animal's skin) of the rigid housings 11 of the functional assemblies 10 located between the adjacent flexible connecting portions 20. In this case, the end connection interface structures 12 of the functional assemblies 10 located between the adjacent flexible connecting portions 20 may be provided without the annular protruding ring 121. In addition, although FIG. 7 illustrates an interlocking engagement configuration between the second connection end 20b and its corresponding functional assembly 10, it should be understood that depending on actual needs, the first connection end 20a may also be connected to its corresponding functional assembly 10 using the specific interlocking engagement configuration shown in FIG. 7.

Compared with the prior art, the wearable electronic device 100 according to the present disclosure provides the following beneficial effects.

First, by distributing multiple functional assemblies 10 and providing a flexible connection between adjacent functional assemblies 10, the wearable electronic device 100 of the present disclosure can adapt to the body surface curvature and movement-induced deformation of the animal, thereby reducing local compression and stress concentration on the animal.

Second, each functional assembly 10 is equipped with an independent rigid housing 11, which facilitates reliable protection and sealing while still allowing the overall assembly to flexibly conform to the animal's body.

Third, the wearable electronic device 100 eliminates the need for a unified base structure or main unit structure, thereby reducing the discomfort associated with bulky, concentrated components and improving wearing stability.

It is worth noting that although the drawings illustrate the end connection interface structure 12 as including an annular protruding ring 121 (121′), it should be understood that depending on actual needs, the end connection interface structure 12 may also include an annular groove, a plug-in portion, a snap-fit portion, or a positioning flange, and thus the present disclosure is not limited to the configurations shown in the drawings.

The above disclosure is only preferred embodiments of the present disclosure and shall not be used to limit the scope of rights of the present disclosure. Accordingly, equivalent variations made in accordance with the claims of the present disclosure shall fall within the scope of the present disclosure.

What is claimed is:

1. A wearable electronic device for an animal, comprising:
at least two functional assemblies spaced apart from each other, each of the functional assemblies having an independent rigid housing;
a flexible connecting portion connected between two adjacent functional assemblies and configured to permit relative positional and orientational changes between the two adjacent functional assemblies; and
a wearing member, on which at least a portion of the functional assemblies is mounted;
wherein, when the wearable electronic device is worn on the animal, the two adjacent functional assemblies undergo relative positional and orientational changes via the flexible connecting portion, thereby accommodating torso or neck deformation of the animal during movement, and accommodating differences in torso or neck curvature caused by different animal body sizes.

2. The wearable electronic device of claim 1, wherein the wearing member is a collar, a chest strap, or a harness.

3. The wearable electronic device of claim 1, wherein all of the functional assemblies are spaced apart from each other along a length direction of the wearing member.

4. The wearable electronic device of claim 1, wherein the flexible connecting portion is configured to permit an angular change between two adjacent functional assemblies; or the flexible connecting portion is configured to permit an angular change and a translational movement between two adjacent functional assemblies.

5. The wearable electronic device of claim 1, wherein the flexible connecting portion is an elastomeric connector, a bellows-structure connector, a serpentine connector, a flexible sheet-like connector, or a fabric composite connector.

6. The wearable electronic device of claim 1, wherein an end portion of each functional assembly is provided with an end connection interface structure configured to cooperate with the flexible connecting portion; and the end connection interface structure is connected to the flexible connecting portion by overmolding, snap-fitting, or interlocking engagement.

7. The wearable electronic device of claim 6, wherein the end connection interface structure is located on the rigid housing; and the end connection interface structure comprises an annular protruding ring, an annular groove, a plug-in portion, a snap-fit portion, or a positioning flange.

8. The wearable electronic device of claim 6, wherein each functional assembly defines a communication channel therein, and the flexible connecting portion defines an electrical connection channel aligned and in communication with the communication channel.

9. The wearable electronic device of claim 8, wherein the electrical connection channel is provided with a conductive member configured to electrically connect two adjacent functional assemblies; and wherein the conductive member is an electrical wire or a flexible circuit board.

10. The wearable electronic device of claim 8, wherein:
the flexible connecting portion is provided with a rigid tongue inserted into the end connection interface structure through the communication channel, the electrical connection channel extending through the rigid tongue in an insertion direction;
the end connection interface structure comprises an annular protruding ring arranged around the communication channel;
the functional assembly is provided with a pressing plate; and
when the pressing plate presses against the rigid tongue in a direction intersecting the insertion direction, the pressing plate causes the rigid tongue to continue moving in the insertion direction and causes the annular protruding ring to sealingly abut the flexible connecting portion.

11. The wearable electronic device of claim 8, wherein the end connection interface structure comprises an annular protruding ring arranged around the communication channel and overmolded with the flexible connecting portion.

12. The wearable electronic device of claim 11, wherein a sidewall of the annular protruding ring defines an annular groove extending circumferentially around the annular protruding ring, the annular groove being overmolded with the flexible connecting portion.

13. The wearable electronic device of claim 1, wherein each functional assembly further comprises at least one of a positioning module, a sensing module, a wireless communication module, or a power module.

14. The wearable electronic device of claim 13, wherein the wireless communication module comprises at least one of a cellular communication module, a Bluetooth module, or a Wi-Fi communication module.

15. A flexible connecting portion for a wearable electronic device for an animal, wherein the flexible connecting portion is connected between two adjacent functional assemblies that are spaced apart from each other in the wearable electronic device, the flexible connecting portion comprising:
a first connection end configured to cooperate with an end connection interface structure of a first one of the two adjacent functional assemblies;
a second connection end configured to cooperate with an end connection interface structure of a second one of the two adjacent functional assemblies; and
a flexible or deformable connection body located between the first connection end and the second connection end, the connection body permitting relative positional and orientational changes between the two adjacent functional assemblies.

16. The flexible connecting portion of claim 15, wherein the flexible connecting portion defines an electrical connection channel therein, and each functional assembly defines a communication channel aligned and in communication with the electrical connection channel.

17. The flexible connecting portion of claim 16, wherein the electrical connection channel is provided with a conductive member configured to electrically connect two adjacent functional assemblies; and wherein the conductive member is an electrical wire or a flexible circuit board.

18. The flexible connecting portion of claim 16, wherein the first connection end and the second connection end are configured to be connected to the respective end connection interface structures of the corresponding functional assemblies by overmolding, snap-fitting, or interlocking engagement.
